(19) United States
(12) Patent Application Publication
(10) Pub. No.: US 2012/0247998 A1
(43) Pub. Date: Oct. 4, 2012

(54) BEVERAGE CONTAINER

(76) Inventor: Andrew C.F. Wahl, Seattle, WA (US)

(21) Appl. No.: 13/075,389

(22) Filed: Mar. 30, 2011

(51) Int. Cl. B65D 21/02; B23P 19/04; B65D 85/00

(52) U.S. Cl. 206/459.5; 220/23.87; 29/428

(57) ABSTRACT

A customizable beverage container that includes an outer shell, an inner shell, a lid, and a straw. The beverage container is configured to permit the outer shell to be selectively removed from the inner shell so that a user may customize the beverage container by writing or marking on an outer surface of the inner shell. Once the outer shell has been reattached to the inner shell, the writings or markings on the inner shell are protected from being unintentionally damaged or wiped away. The beverage container also includes a grip portion positioned near the top of the inner shell to provide a grip surface for the user when removing the inner shell from the outer shell during use.

### BACKGROUND OF THE INVENTION

1. Field of the Invention

The present invention is directed generally to beverage containers and more particularly to customizable beverage containers having an outer shell configured to selectively receive an inner shell that includes a writing surface that allows users to indicate a type of beverage.

2. Description of the Related Art

When customers order a beverage from a restaurant or coffee shop, they are often presented with several options. Such options include type of drink (e.g., coffee, tea, etc.), flavors, one or more types milk to be added, caffeinated or decaffeinated, and the like. Since there are often multiple employees involved in completing the customers' orders, employees taking the customers' orders may write or otherwise mark on beverage containers to indicated the options selected by a customer for a particular beverage. For example, a beverage container may be marked so that it will be apparent that the customer purchased a mocha with one shot of espresso, iced, with caramel sauce, and no whip cream. As can be appreciated, this marking system effectively communicates beverage orders between employees and helps to minimize instances of incorrectly preparing customers' beverage orders.

### BRIEF DESCRIPTION OF THE SEVERAL VIEWS OF THE DRAWINGS

FIG. 1 is a top perspective view of an exemplary beverage container in accordance with an embodiment of the present invention.

FIG. 2 is a partially exploded top perspective view of the beverage container of FIG. 1.

FIG. 3 is a side view of the beverage container of FIG. 1.

FIG. 4 is a side cross-sectional view of the beverage container of FIG. 1.

FIG. 5 is an exploded top perspective view of the beverage container of FIG. 1.

FIG. 6 is an exploded bottom perspective view of the beverage container of FIG. 1.

FIG. 7 is a top view of an outer shell of the beverage container of FIG. 1.

FIG. 8 is a partially exploded top perspective view of the beverage container of FIG. 1, wherein the beverage container includes text, graphics, and handwriting on its surface used to indicate a type of beverage.

### DETAILED DESCRIPTION OF THE INVENTION

Embodiments of the present invention are directed to customizable beverage containers that include an outer shell, an inner shell, and a lid, and often a straw. The beverage containers are configured to permit the outer shell to be selectively removed from the inner shell so that a user may customize the beverage container by writing or marking on an exterior surface of the inner shell. For example, a user may write a particular type of beverage on the surface of the inner shell. Once the outer shell has been reattached to the inner shell, the writings or markings on the inner shell are protected from being unintentionally damaged or wiped away and may be visible through a clear portion of the outer shell. The beverage containers of the present invention also include a grip portion positioned near the top of the inner shell to provide a grip surface for the user when selectively coupling the inner shell with the outer shell during use.

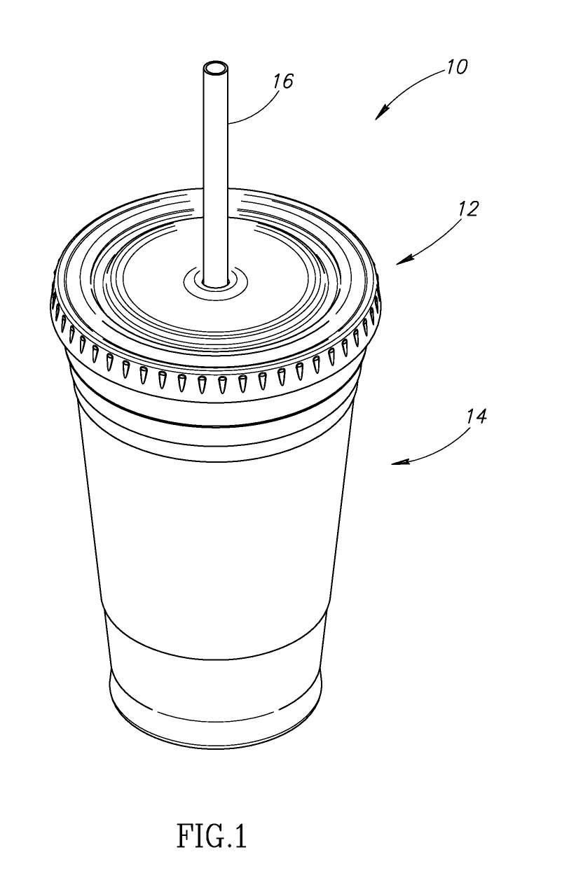

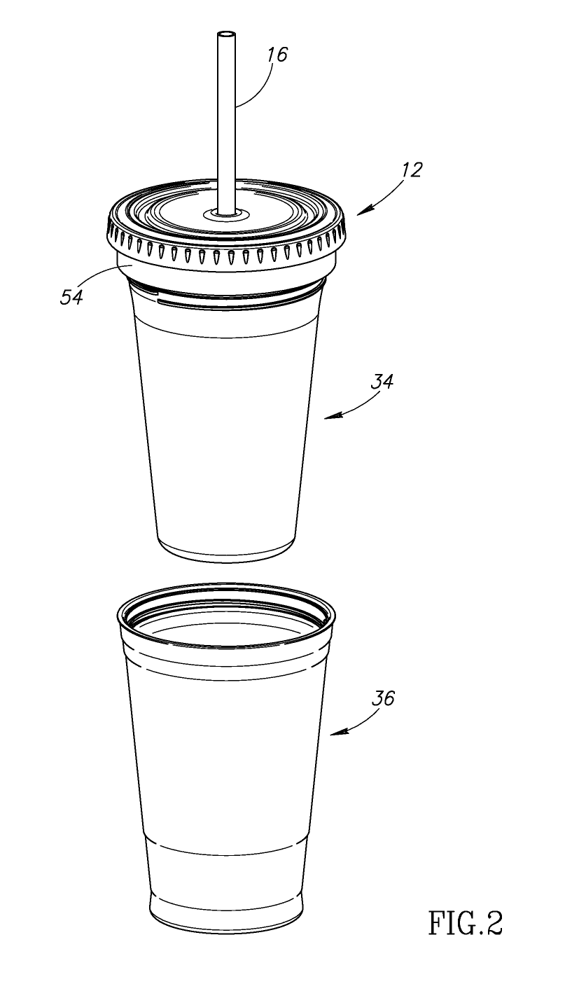

Referring to FIG. 1, aspects of the present invention include a beverage container 10 for use as a tumbler, cup, mug, bottle, or similar storage vessel. The container 10 may be reusable or disposable. For ease of illustration, the container 10 is described and illustrated as being positioned in an upright orientation. Therefore, terms that relate to directions, such as top, bottom, upward, downward, and the like, have been assigned accordingly and are not intended to limit the invention. The container 10 includes a open-ended vessel 14, a lid 12, and a straw 16.

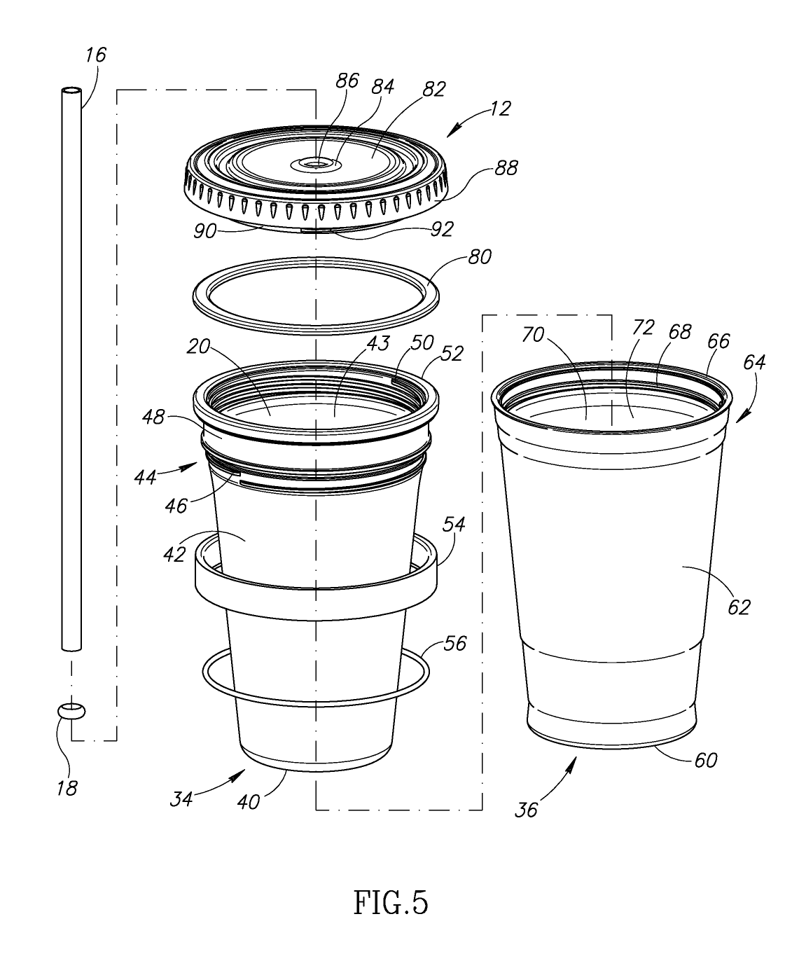

FIG. 4 provides a side view of the container 10 with the vessel 14 sectioned longitudinally along a vertical plane to provide a cross-sectional view of the vessel. The vessel 14 has an inside surface 43 defining a hollow interior portion 20 for storing contents that may be a liquid and/or semi-liquid. Non-limiting examples of liquid or semi-liquid contents stored by the container include beverages (e.g., iced tea, coffee, sodas, etc.), soups, and the like. The vessel 14 may be constructed from opaque materials, semi-transparent materials, transparent materials, or a combination thereof. Materials that may be used to form the vessel include acrylonitrile butadiene styrene (ABS), styrene acrylonitrile (SAN), polycarbonate, polypropylene, or other suitable materials. The vessel 14 is constructed from an inner shell 34 nested inside an outer shell 36 (see FIG. 5). The inner shell 34 comprises the inside surface 43, an outside surface 42 opposite the inside surface, a bottom portion 40, and upper end portion 44 including a rim 52 that defines an opening or outlet into the hollow interior portion 20 through which liquid may pass to enter and exit the vessel 14. The inner shell 34 also includes interior threads 50 formed on the inside surface 43 near the upper end portion 44 below the rim 52 (see FIG. 4).

As shown in FIG. 5, the outer shell 36 comprises an inside surface 70, an outside surface 62 opposite the inside surface, a bottom portion 60, and an upper end portion 64 including a rim 66 that defines an opening into a hollow interior portion 72 through which the inner shell 34 may pass. As shown in FIG. 4, an insulating air gap 100 is defined between the outside surface 42 of the inner shell 34 and the inside surface 70 of the outer shell 36 when the inner shell is nested inside the outer shell.

In the embodiment illustrated, the upper end portion 44 of the outside surface 42 of the inner shell 34 includes exterior threads 46 configured for threaded engagement with corresponding interior threads 68 formed on the inside surface 70 of the upper end portion 64 of the outer shell 36. When a user inserts the inner shell 34 into the outer shell 36 and twists the two shells relative to each other, engagement between the exterior threads 46 of the inner shell and the interior threads 68 of the outer shell removably couple the two shells together. Optionally, an annular sealing member or seal 56 may be disposed between the inner shell 34 and the outer shell 36 to form a seal between them.

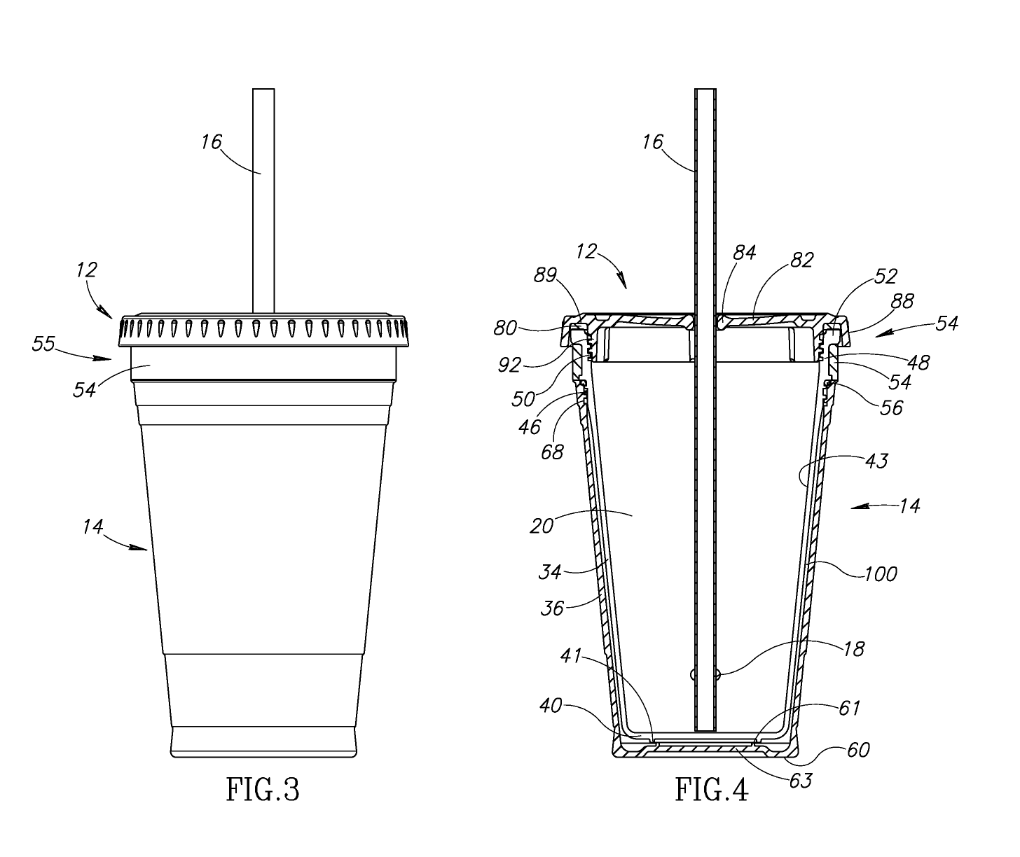

The upper end portion 44 of the outside surface 42 of the inner shell 34 also includes a grip portion 55 formed by a circumferential recess portion 48 configured to receive a grip ring 54 (see FIGS. 3 and 4). The grip ring 54 may be constructed from a rubber-like material configured to provide a non-slip grip surface for a user. The grip ring 54 may be non-rotatably coupled to the inner shell 34 due to friction between the grip ring and the recess portion 48. In operation, a user may grasp the outside surface 62 of the outer shell 36 with one hand and grasp the grip ring 54 with the other hand to twist the inner shell 34 and outer shell relative to each other to selectively attach them together or separate them. Because the inner shell 34 only projects slightly above the outer shell 36 when the two shells are coupled together, grasping the inner shell would be considerably more difficult without the presence of the grip ring 54. Put another way, the grip ring 54 permits the inner shell 34 to project only slightly above the outer shell 36, whereas without the grip ring, the inner shell would need to project farther above the outer shell to provide a suitable grip surface for a user.

As best shown in FIGS. 3 and 4, the depth of the circumferential recess portion 48 and the thickness of the grip ring 54 may be configured to provide a relatively smooth transition profile between the inner shell 34 and the outer shell 36 when coupled together. In other words, the outer circumference of the grip ring 54 when installed in the recess portion 48 is substantially the same as (or slightly larger than) the outer circumference of the outer shell 36 near its rim 66. In addition to being aesthetically pleasing, this arrangement may provide comfort for a user holding the beverage container 10.

While a twist fit arrangement has been disclosed, any method known in the art may be used to couple the inner shell 34 and the outer shell 36 together. For example, the inner shell 34 may include one or more radially outwardly extending projections configured to snap into corresponding recessed portions formed in the outer shell 36. Thus, the invention is not limited by the method used to removably couple the inner shell 34 and the outer shell 36 together.

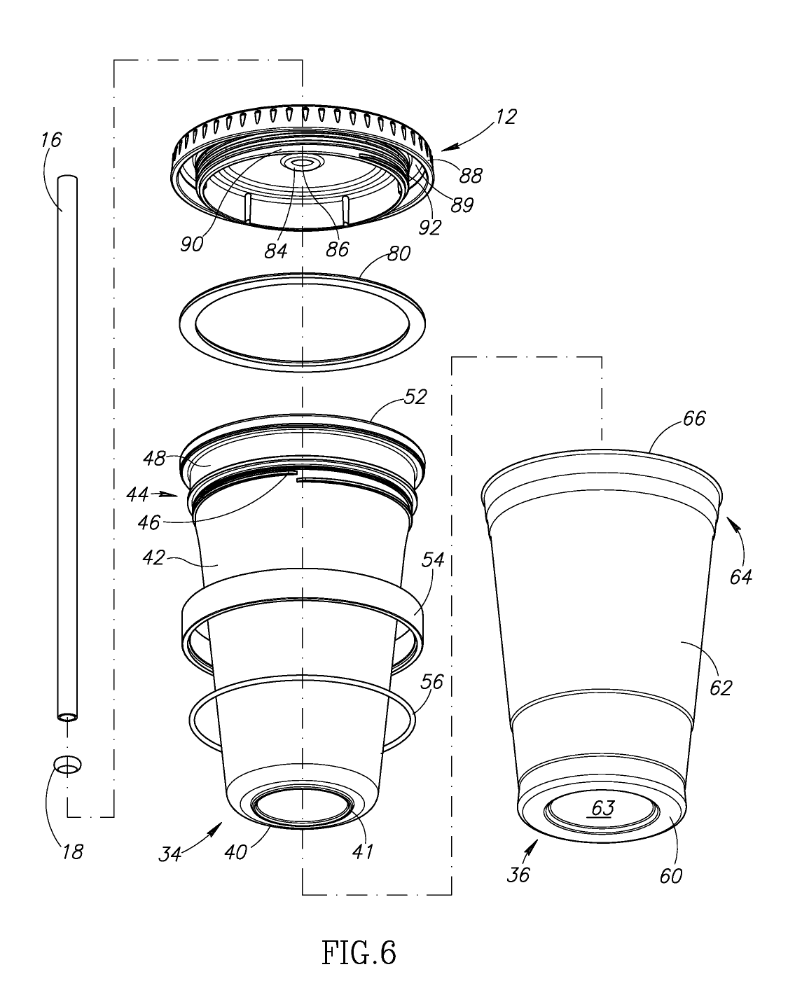

Referring to FIGS. 5 and 6, the lid 12 includes a lid body 82 that has a circular-shaped opening 86 in a central portion 84 thereof into which the straw 16 is insertable as a separate component. The lid 12 also includes a substantially downwardly extending perimeter portion 88 configured to cover part of the upper end portion 64 of the outer shell 36 near its rim 66 (see FIG. 4). The lid 12 also includes a circumferential downwardly extending inner portion 90 that includes exterior threads 92 positioned thereon. The exterior threads 92 of the inner portion 90 of the lid 12 are configured for threaded engagement with the corresponding interior threads 50 of the inner shell 34. As shown in FIGS. 4 and 5, a sealing member or gasket 80 may be disposed in an annular groove 89 formed between the downwardly extending perimeter portion 88 and inner portion 90 of the lid 12. When the lid 12 is coupled to the inner shell 34, the sealing member 80 is positioned on top of and adjacent to the rim 52 of the inner shell and is compressed thereby to form a liquid tight seal between the lid and the inner shell.

Referring to FIGS. 4 and 5, the straw 16 may include a straw retaining member or ring 18 that is removably or fixedly coupled thereto on a portion of the straw below the lid 12. The ring 18 may be sized to be larger than the opening 86 of the lid 12 so that, when installed, the ring 18 prevents the straw 16 from being removed from the container 10. As can be appreciated, this arrangement may reduce the likelihood that the straw 16 will be misplaced by a user.

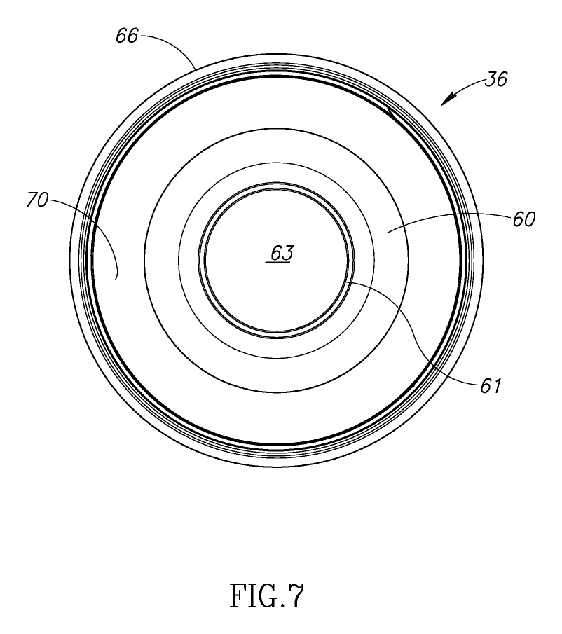

Referring now to FIGS. 4, 6, and 7, the outer shell 36 has an interior circumferential guide wall 61 (see FIG. 7) upwardly extending from a raised central portion 63 of its bottom portion 60. Further, the inner shell 34 has a circumferential guide wall 41 downwardly extending from its bottom portion 40. As shown in FIG. 4, the guide wall 41 of the inner shell 34 is spaced radially outward from the guide wall 61 of the outer shell 36. Thus, the downwardly extending guide wall 41 of the inner shell 34 forms a recess configured to receive the upwardly extending guide wall 61 of the outer shell 36. When so received, an outer surface of the upwardly extending guide wall 61 may be adjacent an inner surface of the downwardly extending guide wall 41. This arrangement may function to maintain the alignment between the inner shell 34 and the outer shell 36 when they are rotated relative to each other.

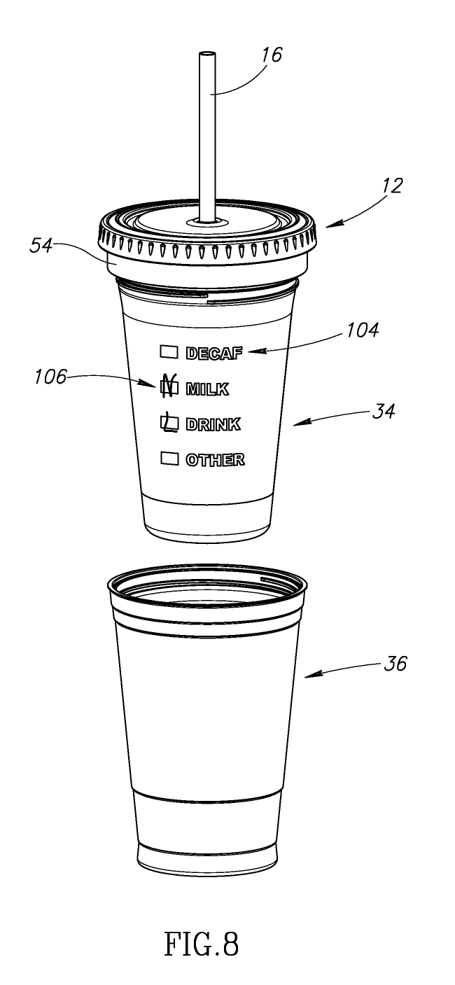

Referring to FIG. 8, the outside surface 42 of the inner shell 34 may include printed text or graphics 104. These graphics 104 may be used for indicating a particular type of beverage for the container 10. For example, the graphics 104 may provide boxes and labels for a user to indicate a type of beverage, whether a beverage is caffeinated or decaffeinated, types of milk, or other options.

The outside surface 42 may also be configured as a writing surface that allows a user to write or otherwise mark thereon to indicate a beverage selection. A variety of writing devices may be used for marking on the outside surface 42, including pens, markers, or any other erasable or non-erasable writing device. FIG. 8 shows an example of handwriting 106 on the outside surface 42 of the inner shell 34. In this example, the handwriting 106 may be used to indicate that the container 10 is to be filled with a café latte (L) made with regular espresso (“decaf” box is unchecked) and non-fat milk (N). As can be appreciated, once the inner shell 34 has been nested inside the outer shell 36 as described above, the outer shell will protect the handwriting 106 from being smudged or erased unintentionally by a user. Further, if the outer shell 36 is constructed from a semi-transparent or transparent material, the outside surface 42 of the inner shell 34 may be viewable from outside the assembled container 10.

In operation, a user may remove the lid 12 (and straw 16) of the beverage container 10 by threadably disengaging the lid 12 from the inner shell 34 as described above. The user may also threadably disengage the inner shell 34 from the outer shell 36 by grasping the outer shell and grasping the grip ring 54 of the inner shell and rotating the two shells relative to each other. Once the inner shell 34 is separated from the outer shell 36, the user may write or mark on the outside surface 42 of the inner shell to indicate a type of beverage desired. With the lid 12 detached, the hollow interior region 20 of the inner shell 34 may be filled with the type of beverage indicated on the outside surface 42. Then, the beverage container 10 may be reassembled by inserting the inner shell 34 back into the outer shell 36, coupling the shells together by rotating them relative to each other, and replacing the lid 12 by threadably engaging it with the inner shell 34. Alternatively, the beverage container 10 may be reassembled by inserting the inner shell 34 into the outer shell 36 and rotating them relative to each other and then filling the inner shell with the type of beverage indicated on the outer surface 42.

It will be appreciated that the disclosure of the foregoing steps is provided to illustrate the various features and/or arrangements of the beverage container 10 and not to limit the invention. For example, in an embodiment wherein the outer shell 36 is transparent or semi-transparent, a user may only want to separate the outer shell from the inner shell 34 when originally making the writing 106 on the outer surface 42 of the inner shell and when the writing 106 needs to be modified (e.g., to indicate a different type of beverage). In this example, a user that frequently consumes the same type of beverage may only occasionally disengage the outer shell 36 from the inner shell 34.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A beverage container, comprising:
an outer shell defining an outer shell hollow interior with an interior surface and having interior threads disposed on an upper end portion of the interior surface; and
an inner shell at least partially receivable inside the outer shell hollow interior and removably couplable to the outer shell, the inner shell defining an inner shell hollow interior configured for storing a liquid and with an exterior surface, and having exterior threads disposed on an upper end portion of the exterior surface, the exterior threads of the inner shell being configured for threaded engagement with the interior threads of the outer shell, the inner shell further comprising a grip portion disposed above the exterior threads and below an upper end of the exterior surface.

2. The beverage container of claim 1, wherein the inner shell comprises a circumferential recess portion disposed on the exterior surface above the exterior threads and below the upper end of the exterior surface, and the grip portion comprises a grip ring disposed within the circumferential recess portion.

3. The beverage container of claim 1, wherein the exterior surface of the inner shell comprises a writing surface, and at least a portion of the outer shell is transparent or semi-transparent and located to be positioned over the writing surface when the inner shell is received inside the outer shell hollow interior and the exterior threads and the interior threads are in threaded engagement.

4. The beverage container of claim 1, wherein the exterior surface of the inner shell comprises a writing surface having text or graphics printed thereon, such that a user may mark on the writing surface to indicate a type of beverage to be stored in the beverage container.

5. The beverage container of claim 1, further comprising a sealing member disposable between the inner shell and the outer shell to form a seal therebetween.

6. The beverage container of claim 1, wherein at least a portion of the exterior surface of the inner shell is spaced apart from the interior surface of the outer shell to form an air gap therebetween when the inner shell and the outer shell are coupled together.

7. The beverage container of claim 1, wherein the outer shell includes a bottom portion having a first circumferential guide wall extending upwardly therefrom, and the inner shell includes a bottom portion having a second circumferential guide wall extending downwardly therefrom, wherein one of the first guide wall and the second guide wall has a first diameter, and the other of the first guide wall and the second guide wall has a second diameter larger than the first diameter, wherein the guide wall having the second diameter forms a recess configured to receive the guide wall having the first diameter.

8. The beverage container of claim 1, wherein at least one of the inner shell and the outer shell are formed from a material selected from the group of materials comprising: acrylonitrile butadiene styrene (ABS), styrene acrylonitrile (SAN), polycarbonate, and polypropylene.

9. The beverage container of claim 1, further comprising a lid that is selectively couplable to an open end of the inner shell.

10. The beverage container of claim 9, wherein the inner shell further comprises an interior surface and interior threads disposed on an upper end portion of the interior surface, and the lid comprises a downwardly extending portion having exterior threads disposed thereon configured for threaded engagement with the interior threads of the inner shell.

11. The beverage container of claim 9, wherein the lid includes an opening therein having a first width, the beverage container further comprising:
a straw having a second width that is smaller than the first width such that the straw may pass freely through the opening of the lid; and
a straw retaining member coupled to the straw and having a dimension that is larger than the first width, the straw retaining member being operative to prevent the straw from being removed from the remainder of the beverage container during use.

12. A beverage container, comprising:
an outer shell defining an outer shell hollow interior with an interior surface and having a coupling portion disposed on an upper end portion of the interior surface; and
an inner shell at least partially receivable inside the outer shell hollow interior and removably couplable to the outer shell, the inner shell defining an inner shell hollow interior configured for storing a liquid and with an exterior surface, and having a coupling portion disposed on an upper end portion of the exterior surface, the coupling portion of the inner shell being configured for selective coupling with the coupling portion of the outer shell, the inner shell further comprising a grip portion disposed above the coupling portion of the inner shell and below an upper end of the exterior surface.

13. The beverage container of claim 12, wherein the inner shell comprises a circumferential recess portion disposed on the exterior surface above the coupling portion of the inner shell and below the upper end of the exterior surface, and the grip portion comprises a grip ring disposed within the circumferential recess portion.

14. The beverage container of claim 12, wherein the exterior surface of the inner shell comprises a writing surface having text or graphics printed thereon, such that a user may mark on the writing surface to indicate a type of beverage to be stored in the beverage container.

15. The beverage container of claim 12, wherein the inner shell further comprises a lid coupling portion, and the beverage container further comprising a lid having a downwardly extending portion with a coupling portion configured for selective coupling with the lid coupling portion of the inner shell.

16. The beverage container of claim 15, wherein the lid coupling portion of the inner shell is disposed on an inner surface of the inner shell, and the coupling portion of the lid is disposed on an outer surface of the downwardly extending portion of the lid.

17. The beverage container of claim 12, wherein the outer shell is transparent or semi-transparent.

18. A beverage container, comprising:
an outer shell defining an outer shell hollow interior and having interior threads disposed on an interior surface at an upper end portion below an outer shell rim;
an inner shell at least partially receivable inside the outer shell hollow interior and removably couplable to the outer shell, the inner shell defining an inner shell hollow interior configured for storing a liquid, and having exterior threads disposed on an exterior surface near an upper end portion below an inner shell rim, the exterior threads being configured for engagement with the interior threads of the outer shell, the inner shell further comprising a circumferential recess portion disposed on the exterior surface above the exterior threads and below the inner shell rim; and
a grip ring disposed within the circumferential recess portion of the inner shell and non-rotatably coupled to the inner shell.

19. A method of using a beverage container, the beverage container comprising an outer shell defining an outer shell hollow interior and having interior threads disposed on an interior surface at an upper end portion below an outer shell rim; and an inner shell at least partially receivable inside the outer shell hollow interior and removably couplable to the outer shell, the inner shell defining an inner shell hollow interior configured for storing a liquid, and having exterior threads disposed on an exterior surface near an upper end portion below an inner shell rim, the exterior threads being configured for engagement with the interior threads of the outer shell, the inner shell further comprising a grip portion disposed above the exterior threads and below the inner shell rim, the method comprising:
positioning at least a portion of the inner shell inside the outer shell hollow interior; and
rotating the inner shell and outer shell relative to each other to cause the interior threads of the outer shell to engage with the exterior threads of the inner shell and position the grip portion extending above the outer shell rim.

20. The method of claim 19, further comprising:
marking on the exterior surface of the inner shell to indicate a type of beverage prior to positioning at least a portion of the inner shell inside the outer shell hollow interior.

21. The method of claim 19, further comprising grasping an exterior surface of the outer shell and grasping the grip portion of the inner shell when rotating the inner shell and the outer shell relative to each other.
